(19) United States
(12) Patent Application Publication
(10) Pub. No.: US 2008/0243523 A1
(43) Pub. Date: Oct. 2, 2008

(54) SYSTEM AND METHOD FOR CUSTOMIZING AND DELIVERING COSMETIC PRODUCTS

(76) Inventor: Gene Beilis, Fair Lawn, NJ (US)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/692,434

(22) Filed: Mar. 28, 2007

(51) Int. Cl. G06Q 30/00

(52) U.S. Cl. 705/1

(57) ABSTRACT

Systems and methods for providing a consumer with a customized cosmetic product. The system includes a professional evaluator effective to examine the consumer and determine specifications to be used in preparing a customized cosmetic product for the consumer. Additionally, the system includes a cosmetic product manufacturer effective to produce a cosmetic product based on the specifications determined by the professional evaluator. An interface exists between the professional evaluator and the cosmetic product manufacturer effective to communicate from the evaluator to the cosmetic product manufacturer the specifications. The specifications may include details of patient's condition to be treated, desired properties of the cosmetic product to be produced, and ingredients to be used in formulating the cosmetic product. Finally, the system includes a distribution channel for making a cosmetic product, produced by the cosmetic product manufacturer based on the specifications, available to the consumer.

### FIELD OF THE INVENTION

The present invention relates generally to systems and methods for customizing cosmetic products for a consumer and delivering said products to the consumer. More specifically, the present invention relates to systems and methods for providing a consumer with cosmetic products that are custom created for the consumer based on specifications provided by a professional evaluator who has evaluated the consumer.

### BACKGROUND OF THE INVENTION

Customized cosmetics have recently come into high demand. Traditionally, cosmetic products for treating an array of skin/hair conditions have been marketed en mass. In order to maximize sales, manufacturers must make the products in a manner that is appropriate for the majority of consumers. Products are generally only available for the most common conditions and for the most common skin or hair types.

Until recently, the demand for customized cosmetics stemmed from people with less common conditions who required a product that was not generally available. However, there are many other reasons for consumers to turn to customized products. If a consumer has two conditions that need to be treated, there may be no product on the mass market that combines treatment for both conditions. Rather than purchasing multiple products in order to treat the multiple conditions, a single customized product can now be purchased to treat both conditions.

Additionally, even though a mass market product may be sufficient to treat a condition, it is usually not a perfect match for any given individual consumer. For example, although a cream may treat a particular condition it may be stronger than necessary or may not be an ideal cream for the particular consumer's skin type. A customized cream would overcome this deficiency.

Finally, there are many characteristics of cosmetic products that can be altered to a consumer's preference that do not affect the functionality of the product. For example, a consumer may prefer thicker creams to thinner creams. Although the viscosity of the product is not critical to treatment, it is a variable that can be customized to the consumer's preference.

In order to meet the demand for customized cosmetics, many manufacturers have begun taking orders from consumers to create custom products. Additionally, many cosmeticians and medical doctors have begun creating their own custom formulations to sell to their patients. However, there are a number of drawbacks to these types of products. While a consumer may communicate to a manufacturer what type of product they would like to use in treating a given condition or conditions, often they are not sophisticated enough to properly evaluate their condition or even to determine what they really want from the product. Lack of extensive education and experience in the dermatologic and cosmetic fields leaves consumers without the proper tools to evaluate or even to articulately describe their conditions to a manufacturer. Consequently, the manufacturer cannot possibly create a customized product that will give the consumer an optimized result. Furthermore, the consumer may request ingredients or qualities in the product that are not compatible with one another or that mitigate each others efficacy.

Regarding products that are custom made by a medical or cosmetological professional, these products are still not customized for the individual patient or consumer. The products are only customized to the preferences of the professional without regard to the specific needs of the consumer. Accordingly, new and improved systems and methods are required to facilitate the customization of cosmetic products based on specifications described by a licensed skincare professional after evaluating the consumer.

### SUMMARY OF THE INVENTION

It is therefore an object of the present invention to provide new and improved systems and methods for providing custom cosmetic products to a consumer that overcome the limitations of the prior art.

Briefly, the objects of the invention are carried out by the system of the present invention for providing a consumer with a customized cosmetic. The system includes a professional evaluator effective to examine the consumer and determine specifications to be used in preparing a customized cosmetic product for the consumer. Additionally, the system includes a cosmetic product manufacturer effective to produce a cosmetic product based on the specifications determined by the professional evaluator. An interface exists between the professional evaluator and the cosmetic product manufacturer effective to communicate from the evaluator to the cosmetic product manufacturer the specifications. The specifications may include one or more of the following:
(i) details of patient's condition to be treated,
(ii) desired properties of the cosmetic product to be produced, and
(iii) ingredients to be used in formulating said cosmetic product.

Finally, the system includes a distribution channel for making a cosmetic product, produced by the cosmetic product manufacturer based on the specifications, available to the consumer.

The method according to the invention for providing a consumer with a customized cosmetic product includes the following steps: First, the consumer is evaluated by a professional evaluator to determine certain specifications to be followed in preparing a custom cosmetic product. The professional evaluator then communicates the specifications to a manufacturer. The manufacturer prepares a customized product for the consumer based on the specifications supplied by the professional evaluator. Finally, the product is made available to the consumer via a distribution channel.

### BRIEF DESCRIPTION OF THE DRAWINGS

A more complete appreciation of the present invention and many of the attendant advantages thereof will be readily understood by reference to the following detailed description when taken in conjunction with the accompanying drawings, in which:

FIG. 1 illustrates a system according to the present invention.

FIG. 2 illustrates an interface according to the system of the present invention.

FIG. 3 illustrates an exemplary list of questions used with the interface of the system according to the present invention.

FIG. 4 illustrates exemplary menus to be used with the interface of the present invention.

### DESCRIPTION OF THE PREFERRED EMBODIMENTS

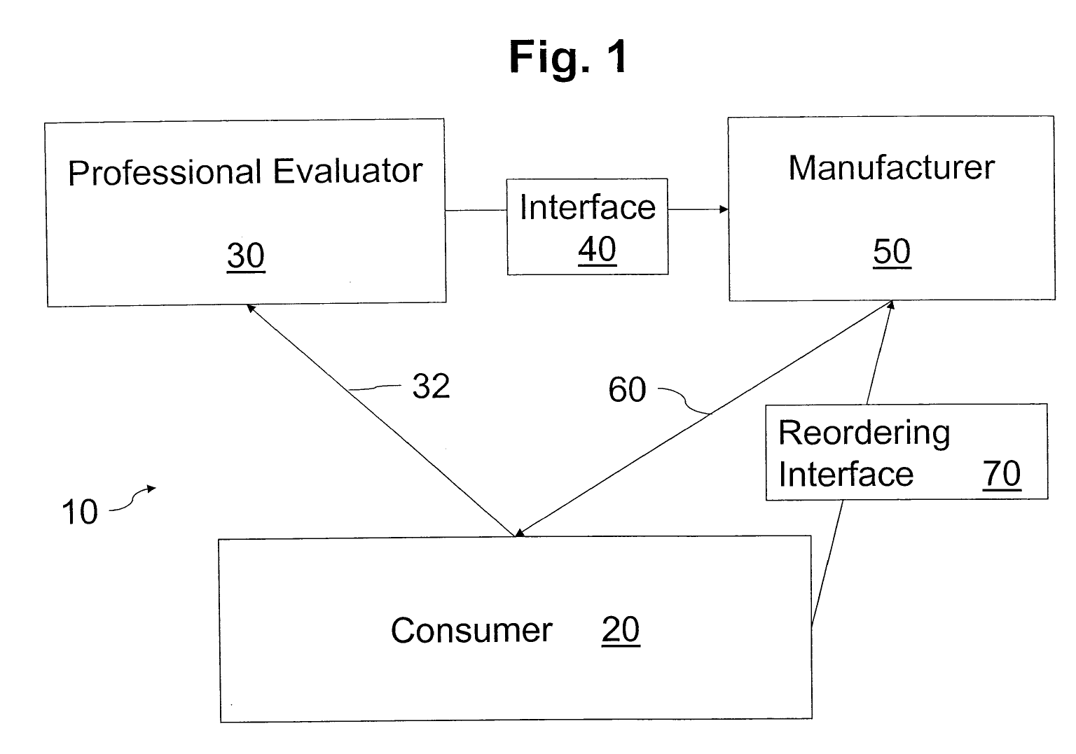

Referring now to the drawings, in which like reference characters designate identical or corresponding parts throughout the several views, the system of the present invention, generally designated 10, is shown in FIG. 1. The system 10 includes a professional evaluator 30 effective to examine the consumer 20 in order to determine specifications to be used in preparing a customized cosmetic product for the consumer 20.

The consumer 20 goes to the professional evaluator 30 for an evaluation 32 of the condition the consumer would like to have treated. The condition may be any dermatologic or cosmetic issue, such as dry or oily skin, acne, rosacea, dandruff, irritation, eczema, wrinkles, spider veins, liver spots, scars, skin tightening, facials, thinning hair, split ends, etc. It is understood that these are only examples of possible conditions that would require a customized cosmetic product, and this list is in no way limiting. It is also understood that the term “condition” should not only be construed as a problem to be treated. Products intended to improve aesthetics are also included, as the examples indicate.

The consumer 20 is examined by the professional evaluator 30. The professional evaluator 30 is a medical doctor, such as a dermatologist, or a licensed professional in a field associated with skin/hair care, such as a cosmetologist. The important factor is that the evaluator 30 should have formal training in identifying and treating the condition that the consumer 20 would like to have treated. The license or certification can be used by the provider of the system of the present invention to verify an evaluator's credentials and abilities to carry out an evaluation.

The professional evaluator 30 examines 32 the consumer 20 and the consumer's condition. The examination includes inquiring as to what condition the consumer 30 would like to have treated, as well as noting the consumer's preferences for product characteristics. The evaluator may also additionally determine which ingredients would best be used in treating the condition and at what ratios, strengths, and concentrations. Finally, the evaluator makes an overall assessment as to other factors about the consumer that may affect the customized product. Examples of these other factors might include race, age, gender, skin/hair type, etc.

Having a professional evaluator evaluate the consumer's condition is a fundamental part of the present invention. A consumer is generally not capable of describing conditions precisely and accurately. Due to the lack of experience with a given condition, the consumer may not have the sensitivity to notice subtle differences that may be important in treating the condition. Accordingly, a professional evaluator must be the one to carry out the evaluation and provide the specification to the manufacturer for production.

In the most simple embodiment, the specifications determined by the professional evaluator include which ingredients should be used in forming the treatment product. The professional evaluator 30 might also include quantities of particular ingredients, ratios of ingredients, and concentrations and strengths of particular ingredients. In this embodiment, the burden of determining the efficacy of the product and the compatibility of the ingredients falls on the professional evaluator 30 alone. The manufacturer 50 will merely follow the directions received from the evaluator 30.

In a second embodiment, the specifications provided by the evaluator 30 do not include specific ingredients, but rather they include information about the condition to be treated. The specifications in this embodiment are actually descriptions of the condition to be treated. In this case, it is the manufacturer's 50 duty to determine which ingredients will best treat the condition as described by the evaluator 30. Accordingly, it is very important that the condition be described in accurate and precise terms.

In a preferred embodiment, the specifications include both ingredient information and condition description. The manufacturer 50 will follow the evaluator's 30 instructions regarding specific ingredients, but fill in the gaps based on the description of the condition when no specific ingredients are given. It is also preferable that the specifications include desired product properties, such as viscosity, aroma, etc.

An interface 40 is used to facilitate the communication or transmission of the specifications from the professional evaluator 30 to the manufacturer 50. The interface 40 can take many forms. The interface 40 can be a prepared paper form with fields requesting information about the consumer, the condition, specific ingredients, and desired product properties. Alternatively, the interface 40 can be a telephone system wherein the information is communicated to an operator or inputted via an automated telephone menu. In a preferred embodiment, the interface 40 is in the form of a computer network or internet website.

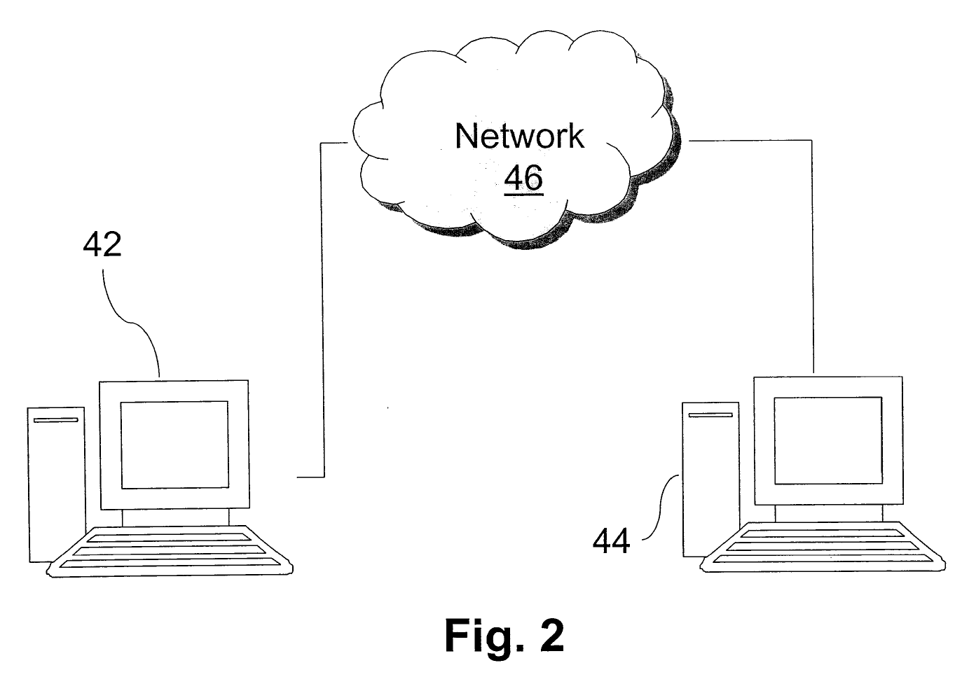

Referring now to FIG. 2, an interface 40 in the form of a computer network is shown. The interface includes a client terminal 42, a network 46, and a manufacturer terminal 44. The client terminal 42 is located at the professional evaluator's 30 place of business and is used by the professional evaluator 30 to input the determined specifications. The evaluator 30 accesses a website that requires a login name and password to ensure the identity of the evaluator. The evaluator must register in order to use the system. Only registered members are given access to the interface system. This insures that only verified licensed professionals are able to make orders for customized products.

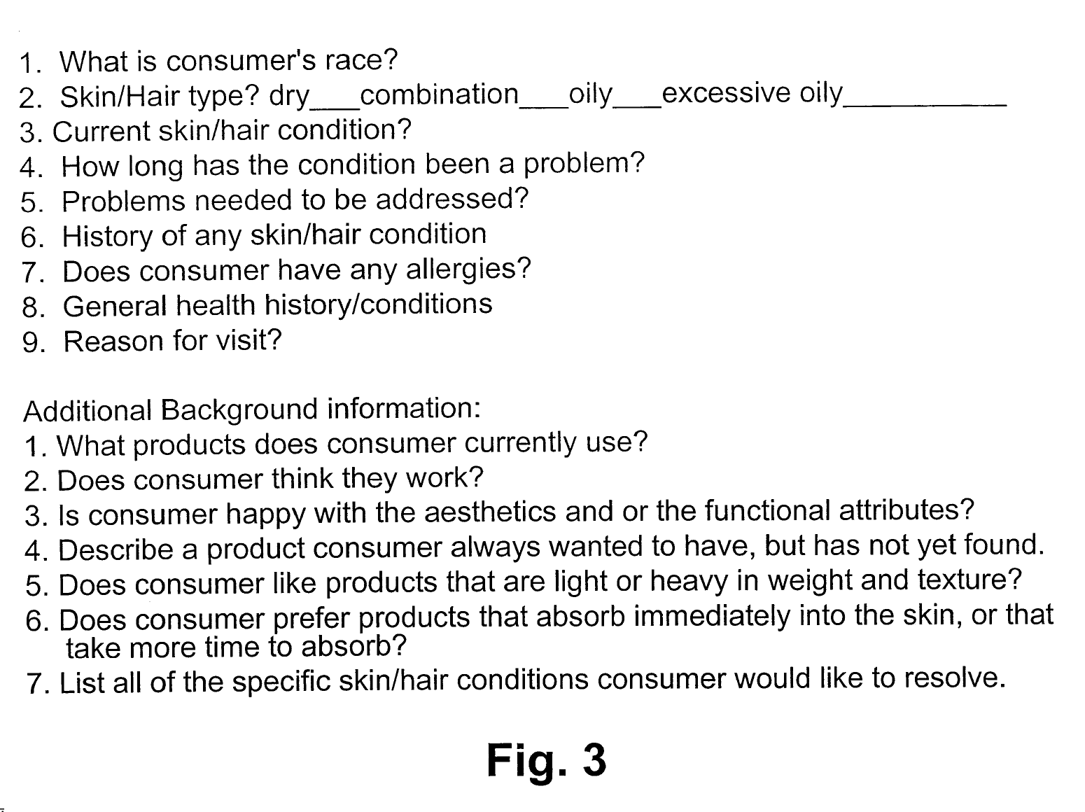

After the evaluator 30 is logged onto the interface system 40, the evaluator 30 is presented with a webpage that queries the evaluator 30 for information about the consumer 20. Referring now to FIG. 3, the requested information is address and contact information, age, gender, race, skin/hair type, skin/hair coloring, known allergies, etc. The next screen requests information about the condition to be treated. The information requested includes identifying the condition, severity, duration, history of recurrence, previous treatments, and success of previous treatments. The third screen covers desired properties of the end product. Usually, these are characteristics that are not related to the treatment of the condition, but rather cater to the consumer's personal preferences. Examples are viscosity/thickness of a cream, aroma, color, etc.

The next screen allows the professional evaluator to include any specific instructions for preparing the cosmetic product. The instructions may include general suggestions such as which particular ingredient should be used to carry out a specific function. Alternatively, more detailed instructions can be given such as listing all ingredients that are to be used or giving exact amounts, ratios and concentrations of the ingredients.

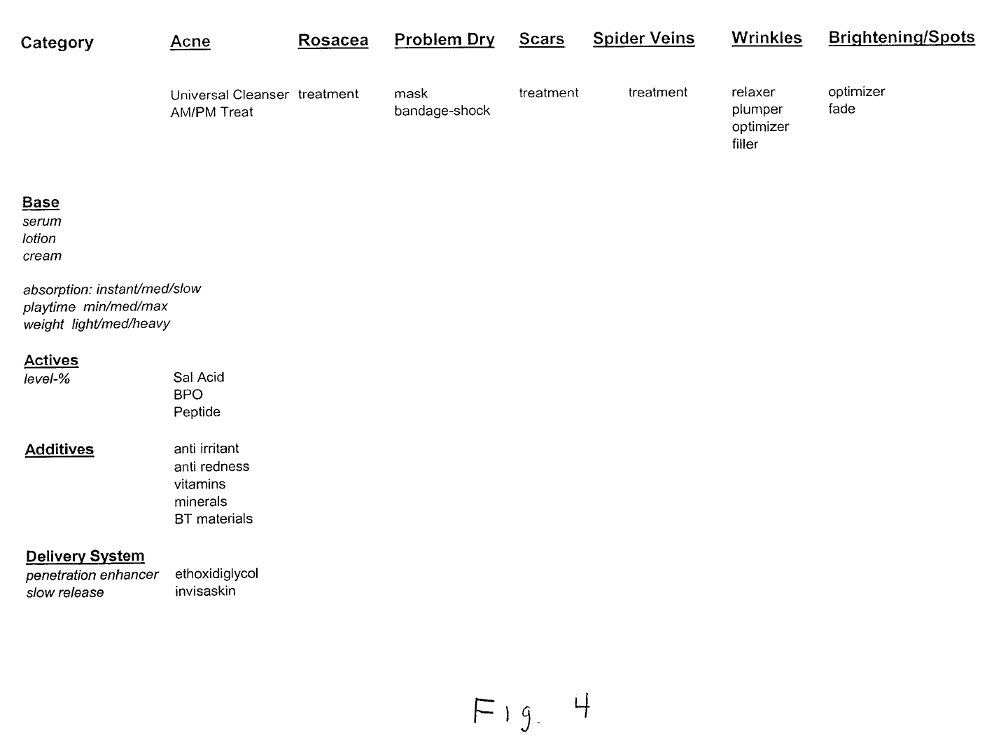

In order to facilitate entry of this data via the interface, a dynamically populated menu may be used. FIG. 4 shows examples of menus that can be used to provide the manufacturer with specifications necessary to develop a treatment product. First, a menu is used to choose the condition or conditions to be treated. Next, a treatment type is selected for each identified condition. Since the menu is dynamically populated based on prior selections, only relevant treatment options will be displayed as a menu item.

The professional evaluator can then select the type of base the product should have, as well as absorption rate, playtime level, and weight. The interface will dynamically populate a menu of available active ingredients and additives that can be used to treat the chosen conditions based on the treatment method selected. Concentrations, ratios, and quantities may also be inputted. The dynamically populated menu insures that the evaluator does not select an ingredient that the manufacturer does not have available. Finally, a delivery system is chosen for the product.

After all the specifications are entered into the system, the delivery method is selected and the data is transmitted to the product manufacturer via the network. The manufacturer 50 receives the data via a manufacturer terminal 44 and uses the specifications to prepare a customized product. As mentioned above, if the specifications contain detailed instructions such as ingredients and their amounts the manufacturer 50 will adhere strictly to the instructions. On the other hand, if the evaluator 30 gave more general or incomplete instructions, then the manufacturer 50 will rely on their expertise in determining what formulation will best treat the condition or conditions described by the evaluator. The manufacturer 50 also takes into consideration the consumer's 20 preferences regarding the characteristics of the product. In a preferred embodiment, the manufacturer 50 will prepare a description of the formulation that the manufacturer 50 intends to prepare and send it to the evaluator 30 for prior approval.

Once the product has been formulated, it is then made available to the consumer 20 via a distribution channel 60. The distribution channel 60 can be direct delivery to the consumer 20. Alternatively, the product can be made available for pickup from a convenient location such as a pharmacy or at the professional evaluator's place of business.

An interface 70 may also be set up to facilitate reordering directly from the manufacturer 50. The consumer 20 can use the interface 70 to view a history of formulations ordered and to request a refill of a given product. The professional evaluator 30 may be permitted to limit the number of refills available to the consumer 20 without a subsequent evaluation.

The description above indicates that a great degree of flexibility is offered in terms of the present invention. Although the present invention has been described in considerable detail with reference to certain preferred versions thereof, other versions are possible. Therefore, the invention is not limited to the preferred embodiments disclosed herein.

1. A system for providing a consumer with a customized cosmetic comprising:
(a) a professional evaluator effective to examine said consumer and determine specifications to be used in preparing a customized cosmetic product for said consumer;
(b) a cosmetic product manufacturer effective to produce a cosmetic product based on said specifications determined by said professional evaluator;
(c) an interface between said professional evaluator and said cosmetic product manufacturer effective to communicate from said evaluator to said cosmetic product manufacturer said specifications;
(d) wherein said specifications include one or more of the following:
(i) details of patient's condition to be treated,
(ii) desired properties of cosmetic product, and
(iii) ingredients to be used in formulating said cosmetic product; and
(e) a distribution channel for making a cosmetic product produced by said cosmetic product manufacturer based on said specifications available to said consumer.

2. The system of claim 1, wherein said professional evaluator is a licensed professional in the cosmetic or healthcare industries.

3. The system of claim 1, wherein said professional evaluator is a medical doctor or a licensed cosmetician.

4. The system of claim 1, wherein said interface is a website.

5. The system of claim 4, wherein said website includes menus of said specifications for said professional evaluator to select from.

6. A method for providing a consumer with a customized cosmetic product comprising the steps of:
(a) evaluating, by a professional evaluator, said consumer;
(b) determining, by said professional evaluator, specifications to be used in formulating a customized cosmetic product for said consumer, wherein said specifications include one or more of the following:
(i) details of patient's condition to be treated,
(ii) desired properties of cosmetic product, and
(iii) ingredients to be used in formulating said cosmetic product;
(c) communicating, by said professional evaluator, said specifications to a cosmetic product manufacturer via an interface;
(d) producing, by said cosmetic product manufacturer, a customized cosmetic product based on said specifications; and
(e) distributing said customized cosmetic product to said consumer via a distribution channel.
